(19) United States
(12) Patent Application Publication
(10) Pub. No.: US 2007/0104903 A1
(43) Pub. Date: May 10, 2007

(54) Bicolor melamine container

(75) Inventor: Su-Chun Shieh, Kaoshiung (TW)

Correspondence Address: Su-Chun Shieh, P.O. Box 166-13, Taipei, 115, TW

(73) Assignee: Hwei Thuang Enterprise Co., Ltd.

(21) Appl. No.: 11/269,249

(22) Filed: Nov. 9, 2005

(51) Int. Cl. B32B 27/08

(52) U.S. Cl. 428/35.7

(57) ABSTRACT

The present invention is aimed to provide a bicolor hollowed out melamine container, an outer shell of the melamine container having a number of hollowed out slits differ from the outer wall in colors, the appearance of the container has bicolor or multicolor effects. In practice the melamine container consists of an inner-cup and an outer shell. In which, the outer shell is a first pigment mortar heated under high pressure by molding, a number of slits formed through the wall of the outer shell, the inner-cup is a second pigment mortar heated under high pressure by molding, and then attached inside to the first pigment mortar integrally and seamlessly as a whole, said first and second pigment mortars are in contrast with different color schemes to show the melamine containers in color contrast with carving patterns slits with three dimensional to catch sense of sight.

### FIELD OF THE INVENTION

The present invention relates to a plastic container, particularly to a melamine container utilized by the customers as dinning utensils.

### BACKGROUND OF THE INVENTION

As shown in FIGS. 1 and 2, a conventional melamine container is manufactured by a kind of mono color hydraulic machine. The steps of manufacturing a conventional melamine container is realized by the steps as following: First interlocking a mono color die to the mono color hydraulic machine, and then put raw material of light color into the mono color die. Finally, melamine containers (10) are made from said light color raw material through a heated under high pressure manufacturing process. But most of the melamine containers manufactured in that way are colorless dine and wine wares (for example, white color). Such colorless or white melamine container results in flaws or defects caused by a greasy touch to obscure the appearance thereof. Besides, the colorless melamine container (10) is to continue using as an old dine and wine ware for many years, which is a matter of indifference to the consumers.

For fully promoting an enhanced market share of the melamine containers as mentioned above, the persons skilled in the arts have ever improved the containers as shown in FIGS. 3 and 4, such a melamine container (40) has a dark color outside surface (for example, red color), and a light color inside surface (for example, white color). The way for manufacturing a melamine container (40) is first to produce a dark color outer shell (20), and then put a counterpart light color powdered material inside the outer shell (20). Heated under high pressure, a light color negative camber inner-cup is formed inside and attached to the dark color outer shell (20). In other words, the light color inner cup is combined to the dark color outer shell integrally to form a bicolor melamine container (40). In addition to an outer dark color outer shell, a light color inner cup is rather bright and colorful than the conventional melamine container with a mono color at sights.

However, take a look at said bicolor melamine container (40) from outside, it still has an outer shell (20) colored in only one dark color, while a light color inner-cup (30) added to enrich the colorful performance of the melamine container (40) is not easily perceived through the outer shell directly, the inner-cup only being perceived by a user happens to look down at or look sideways above the melamine container. Moreover, test the performance of manufacturing a bicolor melamine container is easily to initiate by persons skilled in the art, soon the consumers are tired of these kinds of bicolor melamine containers due to the bicolor is substantially with a mono color appearance which is so-so compared with aforesaid mono color melamine container.

Owing to the aforesaid two kinds of melamine containers hardly satisfy the customers; accordingly, the present invention is aimed to provide a melamine container can increase the added values thereof.

### SUMMARY OF THE INVENTION

Accordingly, point against aforesaid drawbacks, the present invention is to provide a bicolor hollowed out melamine container (70) characterized in that an outer shell (50), a first pigment mortar heated under high pressure by molding, the outer shell (50) has a number of hollowed slits (51); and an inner-cup (60) as a second pigment mortar heated under high pressure by molding and then added to the first pigment mortar, the second pigment mortar is combined to the first pigment mortar integrally and seamlessly as a whole; said first and second pigment mortars s are in contrast with each other, the melamine container showing a well-matched in color, a number of carving patterns slits surface with a sense of sight.

As mentioned above, the first and second pigment mortars are the identical melamine raw material.

As mentioned above, the first and second pigment mortars are in contrast with different colors, the different colors correspond to each other within a well-matched color scheme.

As mentioned above, the first and second pigment mortars are in the same color series, but with dark and light colors respectively.

As mentioned above, a number of the hollowed out slits (51) are arranged in sequence.

As mentioned above, a number of the hollowed out slits (51) are formed at random.

### Effects and Functions

In practice the present invention can be achieved with the advantages over the prior arts as following:

When the hollowed slits (51) are formed through the outer shell (50), the surface of the melamine container (70) can be shaped as a number of convex and concave surfaces in succession unlimitedly to round the outer shell of the melamine container so as to produce a series of three-dimension effect which is highlighted by “carving patterns” of a number of slits. Meanwhile, when the outer shell (50) is in contrast with the inner-cup (60) in different color series, not only the color of the inner-cup (60) can be perceived through the slits (51) formed on the outer shell (50), but also the color of inner cup served as a background shows the different shape of the slits (51). The eye that causes the same color lighter or darker to look different when surrounded by or adjacent to other colors, so called “adjacency effect” can be diminished as a series of adjacent colors in succession appeared in this present invention. Therefore, no matter what the observing angles are, the melamine containers (70) can show the inner and outer colors, especially when casting a sidelong glance, the dark and light color series and strips can be shown with a sense of sight.

When the inner-cup (60) and the outer shell (50) are shown in the same color series but different from each other within a pair of dark and light color scheme in contrast with each other, the slits (51) can also be shown a sense of fading and three dimensional sight effects. Such as the inner-cup is formed as a transparent layer, but the outer shell is formed as a translucent layer.

### BRIEF DESCRIPTION OF THE DRAWINGS

FIG. 1: a perspective view of the first kind of conventional melamine container is illustrated.

FIG. 2: a cross section view of FIG. 1.

FIG. 3: a perspective view of the second kind of conventional melamine container is illustrated.

FIG. 4: a cross section view of FIG. 3.

FIG. 5: a flow diagram of the manufacturing process of the bicolor melamine container is illustrated.

FIG. 6: a perspective view of the outer shell of the bicolor melamine container is illustrated.

FIG. 7: a perspective view of the bicolor melamine container is illustrated.

FIG. 8: a cross section view showing the X-X line of the FIG. 7.

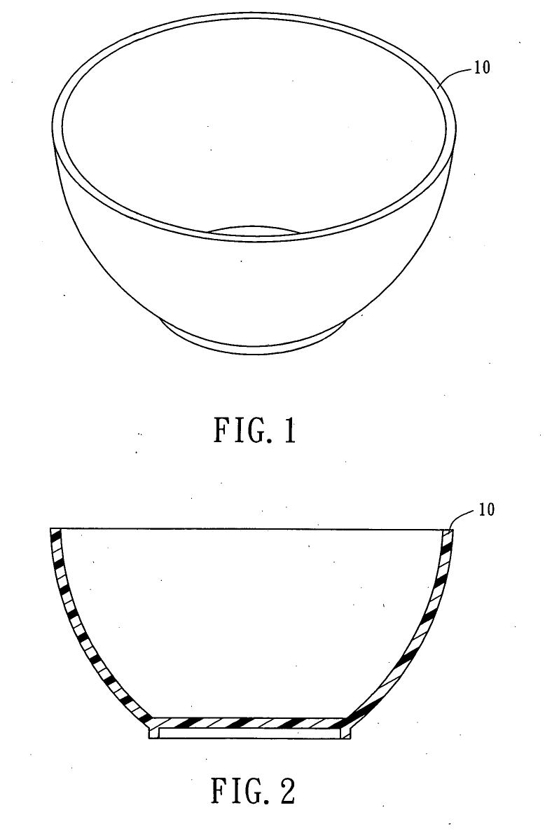

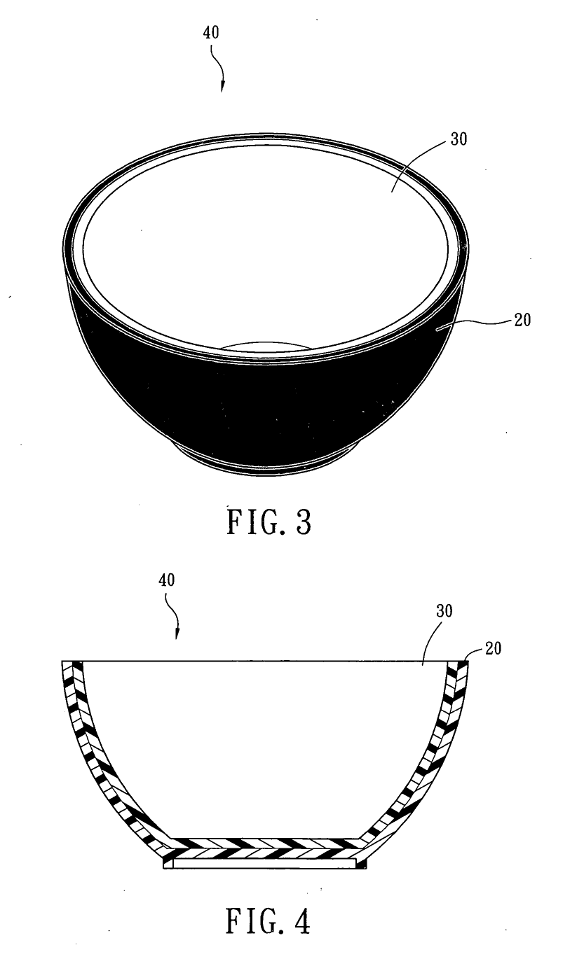

### DETAILED DESCRIPTION OF PREFERRED EMBODIMENTS

The description is described according to the appended drawings hereinafter.

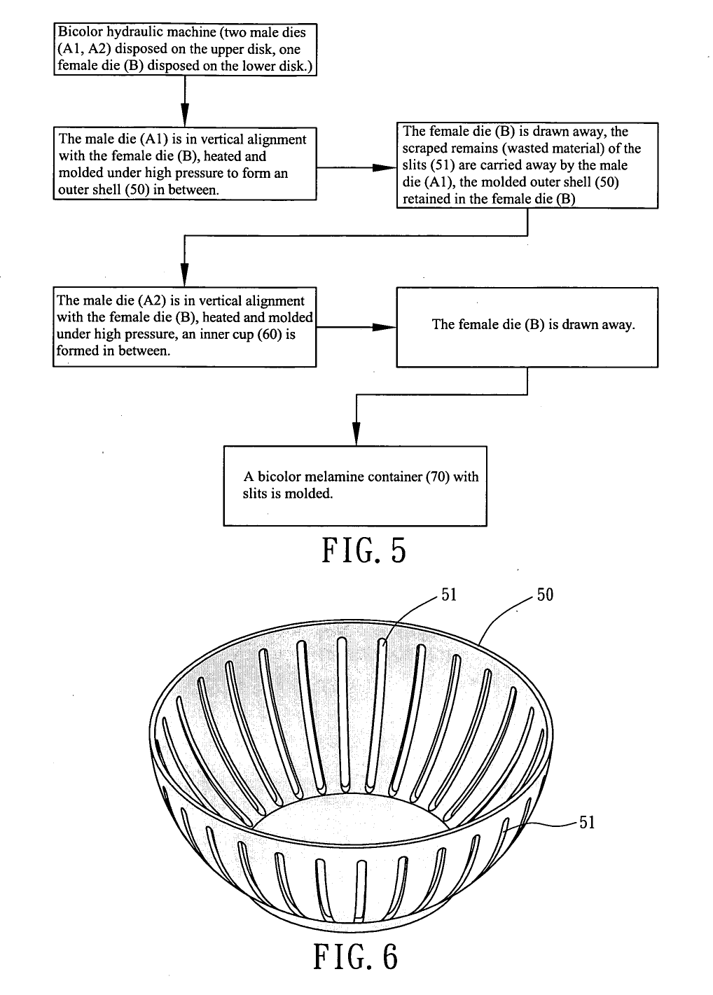

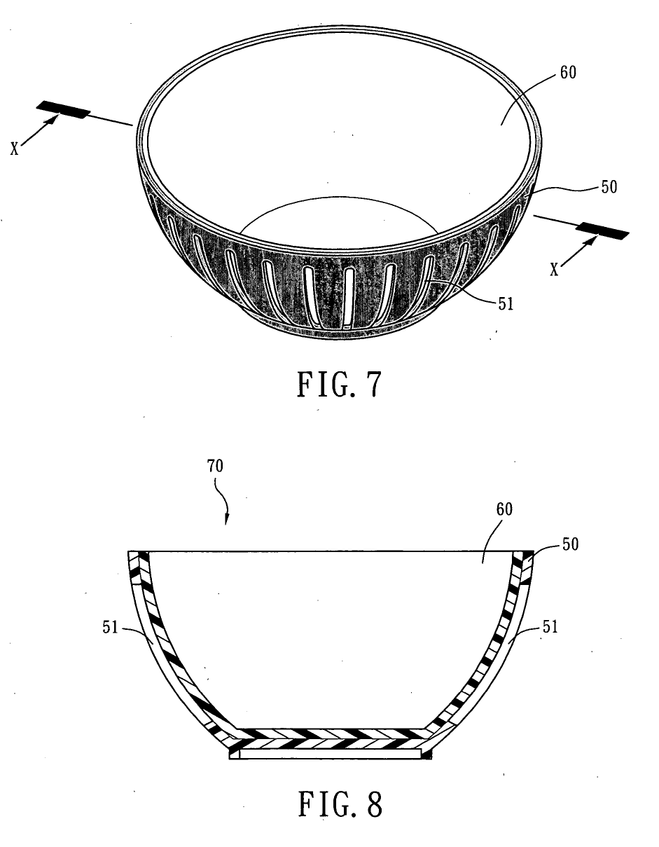

As shown in FIGS. 5˜8, in FIG. 5, a block diagram view of the manufacturing process of the present invention is illustrated. In FIG. 6, an exploded view of the outer shell of the melamine container is illustrated. In FIG. 7, a perspective view showing the inner cup combined to the outer shell of the present invention is illustrated. In FIG. 8, a cross section view of the X-X line along the FIG. 7 is illustrated.

The process of manufacturing a melamine container is realized as following: As shown in FIG. 6, a bicolor hydraulic machine (not shown) with an upper disk can be aligned left or right, two male dies fixed on the upper disk includes a first male die (A1) for producing an outer shell of the melamine container, and a second male die (A2) for producing an inner cup, a female die (B) secured underneath a lower disk; first raw material of dark color melamine (for example, red plastics) put into the female die (B), and then a first color molding key is activated to draw in the first male die (A1) in vertical alignment with the female die (B) integrally as a whole, a dark color outer shell (50) is heated and molded under high pressure. (as shown in FIG. 7) The dark color outer shell (50) is the first pigment mortar. When molding, a number of ribs projected from the inner wall of female die (B) are applied to scrape off the thinner remains (wasted material) around the hollowed slits (51), and then the scraped remains stuck to the groove on the outer wall of the first male die (A1), due to the groove of the first male die (A1) was treated by the blast machine, the plated layer of the groove is frosted with an adhesion to stick the scraped thinner remains. When the female die (B) is drawn away, the upper disk of the hydraulic machine is activated to align left the male die (A1); meanwhile, the scraped thinner remains in the groove are carried away. So, the dark color outer shell (50) with hollowed out silts is molded in the female die B.

Rather, a light color melamine powder (such as white or others) put in the dark color outer shell (50), and then a second molding key is activated, a second male die (A2) is in vertical alignment with the female die (B) integrally as a whole, heated and molded under high pressure to form an inner cup (60) (as shown in FIG. 8) namely a second colored pigment mortar. Because the outer wall of the second male die (A2) is in good shape without any grooves formed through thereof, the ribs projected from the inner wall of the female die (B) are only in contact with the inner cup (60), after the second male die (A2) is drawn away, a bi-color hollowed out melamine container (70) is formed, which is illustrated as shown in FIG. 8.

As shown in FIG. 8, a cross section view of the melamine container (70) is illustrated. The container (70) can be classified into inner and outer layers. In which, the outer layer is formed as a dark color outer shell (50); the inner layer is formed as an inner cup (60). Because the inner and outer layers are made from the same melamine material heated and molded under high pressure combined to form integrally as a whole. Owing to the outer shell (50) has slits (51), a series of carving patterns are shown in sequence on the outer wall of the melamine container (70). The carving patterns can also be formed at random. Whether the carving patterns are formed in sequence or at random, it should be contained in the scope and spirit of the present invention. Rather, the slits (51) are mainly exemplified in the shape of stripes, it is understood that the slits (51) can also be formed in the shape of animals, plants, cartoon characters, or insects.

Moreover, because the slits (51) formed through the wall of the outer shell (50), an inner cup (60) can be perceived by naked eyes through the slits (51), for example, the outer shell (50) is formed in dark red color, the inner cup (60) is in light white color, when seeing through the melamine container (70), the light white color of the inner part (60) is highlighted by the color slits (51) on the dark red color outer shell (50). A melamine container has bi-color with a number of carving patterns is produced.

Next, the inner and outer layers of the melamine container (70) can be designed in different color schemes. They can be also designed in different hues, tones and shades of the same color. Such as the inner cup (60) is transparent, the outer shell (50) is translucent. After combination, the melamine container (70) can provide at least bicolor appearance different from the prior arts.

What is claim claimed:

1. A bicolor hollowed out melamine container (70) characterized in that:
an outer shell (50), a first pigment mortar heated and under high pressure by molding, the outer shell (50) has hollowed out slits (51); and
an inner-cup (60) as a second pigment mortar heated under high pressure by molding, attached to the first pigment mortar integrally and seamlessly as a whole; said first and second pigment mortars arranged in light and dark colors respectively in contrast with each other, the melamine container showing a color contrast, a series of carving patterns slits with a sense of sight.

2. A bicolor hollowed out melamine container (70) as claim 1 claimed wherein the first and second one pigment mortars are the same melamine materials.

3. A bicolor hollowed out melamine container (70) as claim 1 claimed wherein the first and second pigment mortars are arranged in contrast with each other in different colors.

4. A bicolor hollowed out melamine container (70) as claim 1 claimed wherein the first and second pigment mortars are arranged in the same color series, but dark and light colors are shown respectively.

5. A bicolor hollowed out melamine container (70) as claim 1 claimed wherein a number of hollowed out slits (51) are arranged in sequence.

6. A bicolor hollowed out melamine container (70) as claim 1 claimed wherein a number of hollowed out slits (51) are arranged at random.
